(19) United States
(12) Patent Application Publication
(10) Pub. No.: US 2019/0113698 A1
(43) Pub. Date: Apr. 18, 2019

(54) Integrated Heat Sink and Optical Transceiver Including the Same

(71) Applicants: Yu HUANG, West Hills, CA (US); Ping CUI, West Hills, CA (US); Chao TIAN, West Hills, CA (US); Jianhua CHEN, West Hills, CA (US); Shengzhong ZHANG, West Hills, CA (US); Wayne WAINWRIGHT, Ventura, CA (US)

(72) Inventors: Yu HUANG, West Hills, CA (US); Ping CUI, West Hills, CA (US); Chao TIAN, West Hills, CA (US); Jianhua CHEN, West Hills, CA (US); Shengzhong ZHANG, West Hills, CA (US); Wayne WAINWRIGHT, Ventura, CA (US)

(73) Assignee: Source Photonics, Inc., West Hills, CA (US)

(21) Appl. No.: 15/787,492

(22) Filed: Oct. 18, 2017

(51) Int. Cl. G02B 6/42

(52) U.S. Cl. CPC G02B 6/4269; G02B 6/4292; G02B 6/426; G02B 6/4249; G02B 6/4246

(57) ABSTRACT

Embodiments of the disclosure pertain to an optical or optoelectronic transceiver comprising an optical or optoelectronic receiver, an optical or optoelectronic transmitter, a plurality of electrical devices, a housing, and a heat sink having a non-planar surface. The optical or optoelectronic receiver includes a receiver optical subassembly (ROSA). The optical or optoelectronic transmitter includes a transmitter optical subassembly (TOSA). The electrical devices are configured to provide or control one or more functions of the optical or optoelectronic receiver and the optical or optoelectronic transmitter. The housing is over and/or enclosing the optical or optoelectronic receiver and the optical or optoelectronic transmitter. The housing includes a first section and a second section, and is configured to (a) be removably insertable into a cage or socket of a host device and (b) position the first section of the housing outside the cage or socket when the housing is inserted in the cage or socket. The heat sink is over or adjacent to the first section of the housing and is in thermal contact with the housing.

### FIELD OF THE INVENTION

The present invention relates to the field of optical or optoelectronic transceivers, and particularly optical or optoelectronic transceivers including one or more heat sinks.

### DISCUSSION OF THE BACKGROUND

Optical or optoelectronic transceivers (which may be generally identified as “optical transceivers”) convert electrical signals into optical signals and optical signals into electrical signals. An optical transceiver may include receiver and transmitter optical subassemblies, functional circuits, and electrical and optical interfaces, and are significant components in optical fiber communication systems and data storage networks.

Optical or optoelectronic transceivers may generate a significant amount of heat that must be dissipated for efficient operation. As the speed of optical transceiver increases, so too does their power consumption, increasing the generation of thermal energy. The overheating of optoelectrical components may result in a loss of efficiency (e.g., decreased signal power decreased processor speeds, and even failure). Although the cages or sockets (e.g., of a host device or optical switch) into which an optical transceiver is inserted may include heat-dissipating features, there is still a need to dissipate heat in the section of the optical transceiver housing that extends outside of the cage or socket.

FIG. 1A shows a perspective view of a conventional optical transceiver 100 from the top. FIG. 1B shows a perspective view of the conventional optical transceiver 100 from the underside. The conventional optical transceiver 100 includes an optical interface 110, an electrical interface 120, a top cover 130, a bottom cover or base 140, and a handle 150. The optical interface 110 includes a first port 115a and a second port 115b. The conventional optical transceiver 100 does not include a heat sink or other thermal energy dissipating feature or structure.

A housing of the optical transceiver 100 includes the cover 130 and the base 140. The cover 130 may be attached securely to the base 140, completely enclosing the optical interface 110 and the electrical interface 120 within the housing. The handle 150 is configured to allow a user to insert the optical transceiver 100 from the host device into a cage or socket and retrieve the optical transceiver 100 from the cage or socket. The cage may not fully enclose the optical transceiver 100, and thus, part of the housing (including the cover 130 and the base 140) may extend outside the cage.

FIG. 2A shows an SFP optical transceiver 200 with a heat dissipating device integrated into its housing 201. The transceiver 200 has a built-in (e.g., internal) isolator 206. The isolator 206 is configured to divide the transceiver 200 (or the housing 201) into a first cavity 207 close to or facing the optical port 210 and a second cavity 208 close to or facing the electrical port 212. Optical devices (not shown) of the transceiver 200 are located in the first cavity 207, and electrical devices (not shown) are located in the second cavity 208.

After the transceiver 200 is divided into two relatively independent cavities via the isolator 206, the portion 208 containing the electrical devices (which has a relatively high temperature) is thermally isolated from the portion 207 containing the optical devices. Heat produced in the electrical device portion 208 during normal operation can be isolated from the cavity 207 where the optical devices are located, resulting in a relatively low operating temperature for the optical devices.

As shown in FIG. 2B, during normal operation, the first cavity 207 is located outside the switchboard or host device 204, and the second cavity 208 is located inside the switchboard or host device 204. Thus, the effect of the high temperature inside the switchboard or host device 204 on the first cavity 207 containing the optical devices can be minimized during normal operation. Heat produced by the electrical devices inside the second cavity 208 may be isolated from the internal portion of the first cavity 207, and the heat outside the housing 201 and/or inside the switchboard or host device 204 may not significantly influence the operating temperature of the optical devices. Furthermore, the operating temperature of the optical devices in the first cavity 207 may be kept at a relatively low level, thereby increasing the life and efficiency of the transceiver 200.

Air holes 209 are located in the cover 201 in a location corresponding to the first cavity 207 to further increase heat dissipation efficiency from the first cavity 207. The air holes 209 run through the housing 201 and are arranged at predetermined locations throughout the housing 201 (e.g., in an array). Heat exchange between the first cavity 207 and the outside air can be implemented via the air holes 209, thereby maintaining the internal operating temperature of the first cavity 207.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

In one aspect, the present invention relates to an optical or optoelectronic transceiver comprising an optical or optoelectronic receiver, an optical or optoelectronic transmitter, a plurality of electrical devices, a housing, and a heat sink having a non-planar surface. The optical or optoelectronic receiver includes a receiver optical subassembly (ROSA). The optical or optoelectronic transmitter includes a transmitter optical subassembly (TOSA). The electrical devices are configured to provide or control one or more functions of the optical or optoelectronic receiver and the optical or optoelectronic transmitter. The housing is over and/or encloses the optical or optoelectronic receiver and the optical or optoelectronic transmitter. The housing includes a first section and a second section. The housing is configured to (a) be removably insertable into a cage or socket of a host device and (b) position the first section of the housing outside the cage or socket when the housing is inserted in the cage or socket. The heat sink is on or over the first section of the housing and is in thermal contact with the housing. The second section of the housing may be removably insertable into the cage or socket of the host device.

The housing may comprise a cover and a base, upper and lower covers, or first and second cover sections. In some embodiments, the heat sink may be integrated with the housing. In various embodiments, the heat sink may be thermally conductive and/or may dissipate heat away from the transceiver.

In further embodiments, the optical or optoelectronic transceiver may comprise a plurality of heat sinks. In various embodiments, one or more heat sinks may be integrated with or attached or affixed to one cover (e.g., the upper cover or the first cover section), and/or one or more heat sinks may be integrated with or attached or affixed to the other cover (e.g., the base, lower cover, or second cover section). Thus, a first heat sink may be in thermal contact with the upper cover or first cover section, and a second one heat sink may be in thermal contact with the base, lower cover, or second cover section.

In some embodiments, the non-planar surface of the heat sink(s) may comprise a plurality of projections or pillars. The projections or pillars may comprise a plurality of cuboid, rectangular, hexagonal, cylindrical or pin-like structures, and may have an angled or curved interface with the housing or with a plate that is secured to the housing, as well as a curved, planar, or angled outermost surface. The projections or pillars may be organized in a matrix of n rows and m columns, where each of n and m is independently an integer of 2 or more.

In other embodiments, the non-planar surface of the heat sink(s) may comprise a plurality of fins (e.g., alternating ridges and troughs). The fins may be straight, angled, curved, sloped, etc. Each projection, pillar, or fin may be the same or different (e.g., in shape, dimensions, spacing, etc.).

In various embodiments, the housing is a small form factor-compliant housing. The housing may further include a plurality of air holes configured to expose optical, optoelectronic and/or electrical devices in the first section to air outside the housing.

In further embodiments, the optical transceiver may further comprise a de-latching mechanism configured to latch or secure the housing to the cage or socket, and de-latch or release the housing from the cage or socket. At least part of the de-latching mechanism may be under, in or over the first section of the housing. The de-latching mechanism may comprise a projection on or through and/or a depression in the second section of the housing. In such embodiments, when the second section is inserted into the cage or socket and the transceiver is latched in the cage or socket, the first section remains outside the cage or socket, and the housing and the cage or socket are stably connected.

In another aspect, the present invention relates to a method of dissipating heat from an optical or optoelectronic transceiver, comprising placing a heat sink having a non-planar surface (i) on or over a first section of a housing of the optical or optoelectronic transceiver and (ii) in thermal contact with the housing, inserting the optical or optoelectronic transceiver into the cage or socket, and operating the optical or optoelectronic transceiver. The optical or optoelectronic transceiver comprises an optical or optoelectronic receiver having a receiver optical subassembly (ROSA), an optical or optoelectronic transmitter having a transmitter optical subassembly (TOSA), and a plurality of electrical devices configured to provide or control one or more functions of the optical or optoelectronic receiver and the optical or optoelectronic transmitter. The housing encloses and/or is over the optical or optoelectronic receiver and the optical or optoelectronic transmitter. The housing is configured to be removably insertable into a cage or socket of a host device. The housing is further configured to position the first section outside the cage or socket when the housing is inserted in the cage or socket.

In another aspect, the present invention relates to a method of manufacturing an optical or optoelectronic transceiver, comprising placing a housing over an optical or optoelectronic receiver and an optical or optoelectronic transmitter of the optical or optoelectronic transceiver, and attaching, affixing or integrating a heat sink having a non-planar surface (i) on, to or over a first section of a housing and (ii) in thermal contact with the housing. As for other aspects of the invention, the optical or optoelectronic receiver includes a receiver optical subassembly (ROSA) a transmitter optical subassembly (TOSA), and a plurality of electrical devices, each configured to provide or control one or more functions of the optical or optoelectronic receiver and the optical or optoelectronic transmitter. The housing further comprises a second section. The housing (e.g., the second section) is configured to (i) be removably insertable into a cage or socket of a host or storage device, and (ii) position the first section outside the cage or socket when the housing is inserted in the cage or socket.

In various embodiments, the method may comprise attaching, affixing, or integrating a plurality of heat sinks on, to, or over the first section of the housing. For example, the heat sink(s) may be integrated into the first section of the housing.

These and other features and advantages of the present invention will become readily apparent from the detailed description of various embodiments below.

### BRIEF DESCRIPTION OF THE DRAWINGS

FIG. 1A shows a perspective view from the top of a conventional optical

FIG. 1B shows another perspective view of the underside of the conventional optical transceiver of FIG. 1A.

FIG. 2A shows a conventional optical transceiver with a heat dissipating device integrated into its housing.

FIG. 2B shows the conventional optical transceiver of FIG. 2A inserted into a host device, and with the heat dissipating device and its associated housing removed.

FIG. 3A shows a perspective view from the top of an exemplary optical transceiver with a heat sink having a plurality of pins in accordance with one or more embodiments of the present invention.

FIG. 3B shows a perspective view of the underside of the exemplary optical transceiver of FIG. 3A.

FIG. 4 shows a perspective view of an exemplary optical transceiver with a heat sink having a plurality of fins in accordance with one or more embodiments of the present invention.

FIG. 5 shows a flowchart for a method of dissipating heat from an optical or optoelectronic transceiver with a heat sink in accordance with one or more embodiments of the present invention.

FIG. 6 shows a flowchart for a method of manufacturing an optical or optoelectronic transceiver with a heat sink in accordance with one or more embodiments of the present invention.

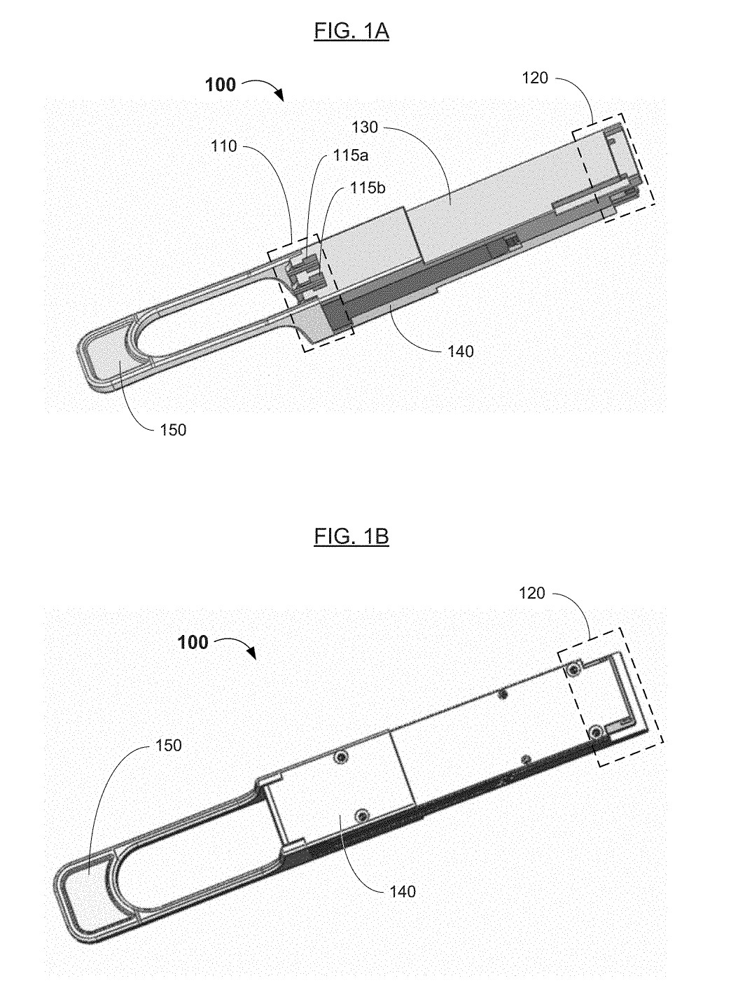

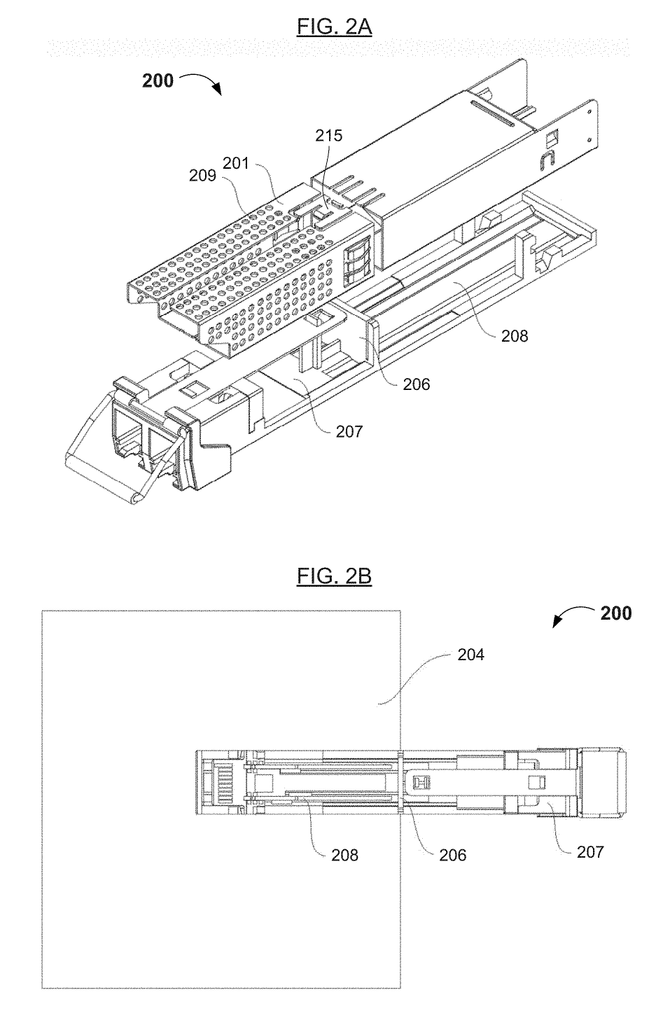

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention. Furthermore, it should be understood that the possible permutations and combinations described herein are not meant to limit the invention. Specifically, variations that are not inconsistent may be mixed and matched as desired.

For the sake of convenience and simplicity, the terms “transceiver,” “optical transceiver” and “optoelectronic transceiver” may be used interchangeably, as may the terms “optical” and “optoelectronic,” the terms “connected to,” “coupled with,” “coupled to,” and “in communication with” (which include both direct and indirect connections, couplings and communications), the terms “mounting,” “affixing,” “attaching” and “securing” (and grammatical variations thereof), and the terms “data,” “information” and “bit(s),” but these terms are generally given their art-recognized meanings.

The term “length” generally refers to the largest dimension of a given 3-dimensional structure or feature. The term “width” generally refers to the second largest dimension of a given 3-dimensional structure or feature. The term “thickness” generally refers to a smallest dimension of a given 3-dimensional structure or feature. The length and the width, or the width and the thickness, may be the same in some cases. A “major surface” refers to a surface defined by the two largest dimensions of a given structure or feature, which in the case of a structure or feature having a circular surface, may be defined by the radius of the circle.

The invention, in its various aspects, will be explained in greater detail below with regard to exemplary embodiments.

### A First Exemplary Optical Transceiver with an External Heat Sink

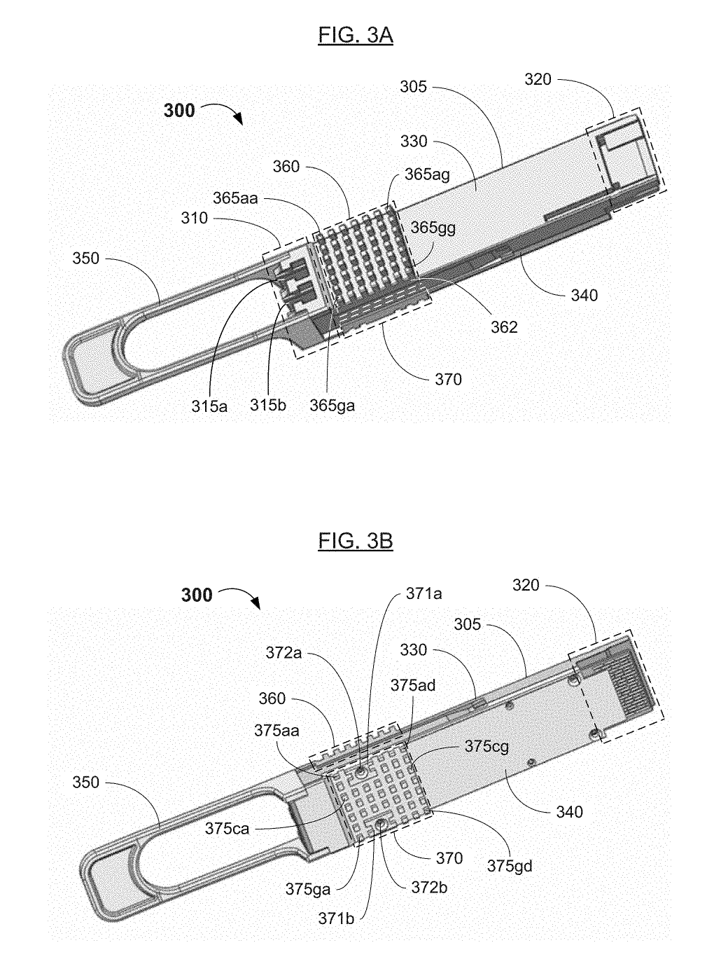

FIG. 3A shows an exemplary optical transceiver 300 including a housing 305, an optical interface 310, optical ports 315a-b, an electrical interface 320, an upper cover 330, a lower cover or base 340, a handle 350, and first and second heat sinks 360 and 370.

The exemplary optical transceiver 300 may include a small form factor-compliant housing. For example, the optical transceiver 300 may be an SFP (Small Form-Factor Pluggable) transceiver, an XFP (10 Gigabit Small Form-Factor Pluggable) transceiver, an SFP+ (Enhanced Small Form-Factor Pluggable) transceiver, or any other standardized optoelectronic transceiver type. The transceiver 300 includes a transmitter optical subassembly (TOSA) and a receiver optical subassembly (ROSA) at the optical interface 310 (e.g., at a first end of the optical transceiver 300). The electrical interface 320 is at a second (e.g., opposite) end of the optical transceiver 300. The optical transceiver 300 includes one or more processing electrical devices in each of a transmitter electrical path and a receiver electrical path (not shown) between the optical interface 310 and the electrical interface 320. The electrical interface 320 and the electrical devices may be on a printed circuit board (PCB). The optical interface 310 is configured to receive one or two optical fibers in communication with one or more other transceivers, and the electrical interface 320 is configured to be coupled to a host or storage device (e.g., a switchboard). The host or storage device may be connected to a network.

The optical interface 310 includes a first port 315a and second port 315b. The first port 315a receives and secures a first optical fiber. A transmitter optical subassembly (TOSA) in the optical transceiver 300 (e.g., adjacent to the first port 315a) includes a laser diode (LD). The second port 315b receives and secures a second optical fiber. A receiver optical subassembly (ROSA) in the optical transceiver 300 (e.g., adjacent to the second port 315b) includes a photodiode (PD). The transmitter electrical path is connected between the electrical interface 320 and the LD. The receiver electrical path is connected between the electrical interface 320 and the PD. The transmitter electrical path typically includes a laser driver. The TOSA may further include a monitoring photodiode configured to sample a signal strength or optical power of the optical signal emitted by the LD. The receiver electrical path may include a transimpedence amplifier (TIA) and a limiting amplifier. Components in both the receiver electrical path and the transmitter electrical path are typically connected to a microcontroller configured to control operations of the various components. An analog-to-digital converter (ADC) may be electrically connected between the monitoring PD and the microcontroller.

The laser diode (e.g., the transmitter) converts an electrical signal (e.g., from a host device connected to the electrical interface 320) to an optical signal. The optical signal is then transmitted through the first optical fiber to another transceiver in the network. The photodiode (e.g., in the receiver) converts an optical signal from the second optical fiber to an electrical signal. After processing by electrical devices in the receiver electrical path, the electrical signal is then transmitted to an external device (e.g., the host) through the electrical interface 320.

The housing 305 of the optical transceiver 300 includes the upper cover 330 and the lower cover or base 340. The upper cover 330 may be attached securely to the lower cover or base 340, completely enclosing the devices between the optical interface 310 and the electrical interface 320 within the housing 305. The handle 350 is configured to allow a user to easily insert the optical transceiver 300 into a cage or socket in the host device (not shown) and retrieve the optical transceiver 300 from the cage or socket. The cage or socket may not fully enclose the optical transceiver 300, and thus, a first part or section of the housing 305 (including the heat sinks 360 and 370) may extend outside the cage or socket.

The housing 305 has a first section and a second section. The first section may be defined in part by the heat sinks 360 and 370, and includes the part of the housing 305 that extends out of the cage or socket when the optical transceiver 300 is inserted into the cage or socket. The second section is not covered by or in physical contact with the heat sinks 360 and 370, and encloses the part of the optical transceiver 300 that is inserted into the cage or socket. Thus, the second section of the housing 305 may be configured to be removably insertable into the cage or socket of a host device, and the heat sinks 360 and 370 may be configured to position the first section of the housing 305 outside the cage or socket when the housing 305 is inserted in the cage or socket.

The optical transceiver 300 may further include a de-latching mechanism (not shown) configured to latch or secure the housing 305 to the cage or socket, and de-latch or release the housing 305 from the cage or socket. At least part of the de-latching mechanism over or adjacent to the first section. The de-latching mechanism may further comprise a projection extending through the housing 305 in the second section and/or a depression in the second section. When the second section is inserted into the cage or socket, the first section remains outside the cage or socket, and the housing 305 and the cage or socket may be stably connected.

The heat sinks 360 and 370 have a non-planar surface and are (i) on, over, or under, and (ii) in thermal contact with the first section of the housing 305. The heat sinks 360 and 370 may comprise a thermally conductive material (e.g., a metal or metal alloy), and may dissipate heat away from the transceiver 300. The heat sink 360 may be integrated with, affixed to, or attached to the upper cover 330. The heat sink 370 may be integrated with, affixed to, or attached to the lower cover or base 340. Alternatively, the optical transceiver 300 may include only one of the heat sinks 360 and 370. In some embodiments, the heat sink(s) 360 and/or 370 may encapsulate, enclose or substantially encapsulate or enclose the first section of the housing 305 (e.g., the heat sink[s] 360 and/or 370 may be present on all four lateral sides of the housing 305).

The non-planar surface of the heat sink 360 comprises a plurality of projections or pillars 365aa-gg (e.g., extending away from the upper cover 330), and the heat sink 370 on the underside of the transceiver 300 comprises a plurality of projections or pillars 375aa-gd (e.g., extending away from the lower cover or base 340, shown in FIG. 3B). Each of the plurality of projections or pillars 365aa-gg and 375aa-gd may extend from 0.1 to 20 mm (or any value or range of values therein) away from the surface of the housing 305. The plurality of projections or pillars 365aa-gg and 375aa-gd comprise a plurality of cuboid, rectangular, hexagonal, cylindrical or pin-like structures, and may have an angled interface with the housing 305 (shown) or with a plate that is affixed or secured to the housing 305. In addition, each of the plurality of projections or pillars 365aa-gg and 375aa-gd may have an angled and/or planar outermost surface (shown) or a rounded and/or curved outermost surface.

The plurality of projections or pillars 365aa-gg is organized in a matrix of 7 rows and 7 columns, although the projections or pillars may be in a matrix of n rows and m columns, where each of n and m is independently an integer of 2 or more (e.g., ≥4, ≥5, ≥6, etc.). Individual projections or pillars 365aa-gg may be spaced apart from adjacent projections or pillars by a distance of 0.1 to 10 mm, or any value or range of values therein. The spacing between projections or pillars in adjacent rows and/or adjacent columns, as well as between adjacent projections or pillars in the same row or column, may be the same or different.

Referring to FIG. 3B, the projections or pillars 375aa-gd may be organized in a matrix similar to the projections or pillars 365aa-gg (e.g., including one or more rows of 7 projections or pillars such as row 375ca-cg and/or one or more columns of 7 projections or pillars such as columns 375aa-ga and 375ad-gd), but in which two or more projections or pillars in adjacent rows and/or columns are combined into a “superpillar” 371a-b. Alternatively, one or more projections or pillars in adjacent rows and/or columns may be absent or missing.

In alternative embodiments, the matrix of the plurality of projections and pillars 365aa-gg and 375aa-gd is in a staggered arrangement (e.g., there is a space between each projection or pillar where a projection or pillar would otherwise be in a regular matrix of rows and columns). In alternative embodiments, the heat sinks 360 and 370 may have a circular or oval shape, and the projections or pillars 365aa-gg and 375aa-gd may be organized in concentric circles or ovals extending outward from the center of each circle or oval.

In an alternative embodiment, the heat sinks 360 and 370 may comprise a plurality of depressions or holes (e.g., in a thermally conductive plate having a thickness of 0.1-20 mm, or any value or range of values therein). The depressions or holes may have a square, rectangular, hexagonal, circular or oval cross-sectional shape. Each of the plurality of depressions or holes may extend from 10% to 100% of the distance through the heat sink 360 or 370. The plurality of depressions or holes may be organized or arranged in a matrix of n rows and m columns, where each of n and m is independently an integer of 2 or more. Alternatively, the depressions or holes may be staggered, concentric, or in another pattern.

The lowermost, planar part of the heat sinks 360 and 370 (e.g., 362 in FIG. 3A) may be integrated with or extend under the upper cover 330 or lower cover 340 in the second section of the housing 305. Such a configuration may facilitate dissipation of thermal energy from the optoelectronic and/or electronic devices within the second section of the housing 305. The optical transceiver 300 may further include one or more fans or other air-moving devices adjacent, affixed or attached to the heat sink 360 or 370 that push or pull lower-temperature air across the projections or pillars 365aa-gg and 375aa-gd, thereby facilitating the dissipation of heat away from the transceiver 300.

FIG. 3B shows a perspective bottom-view of the exemplary optical transceiver 300, including components not shown in FIG. 3A. FIG. 3B shows projections or pillars 375aa-gd similar or identical to those described with respect to FIG. 3A, in addition to “superpillars” 361a-b and holes 362a-b. The holes 362a-b are located in the plates 361a-b, and are configured to receive screws or other fasteners configured to attach, affix or adhere the heat sink 370 to the housing 305 of the transceiver 300. For example, the inner surface of the housing 305 or the heat sink 360 may have a number of holes therein corresponding to the holes 362a-b, with a spiral or other groove therein configured to mate with the screw or other fastener inserted through the holes 362a-b in the plates 361a-b. However, other mechanisms for affixing or securing the heat sinks 360 and 370 to the housing and/or to each other are possible in accordance with aspects of the invention.

### A Second Exemplary Optical Transceiver with an External Heat Sink

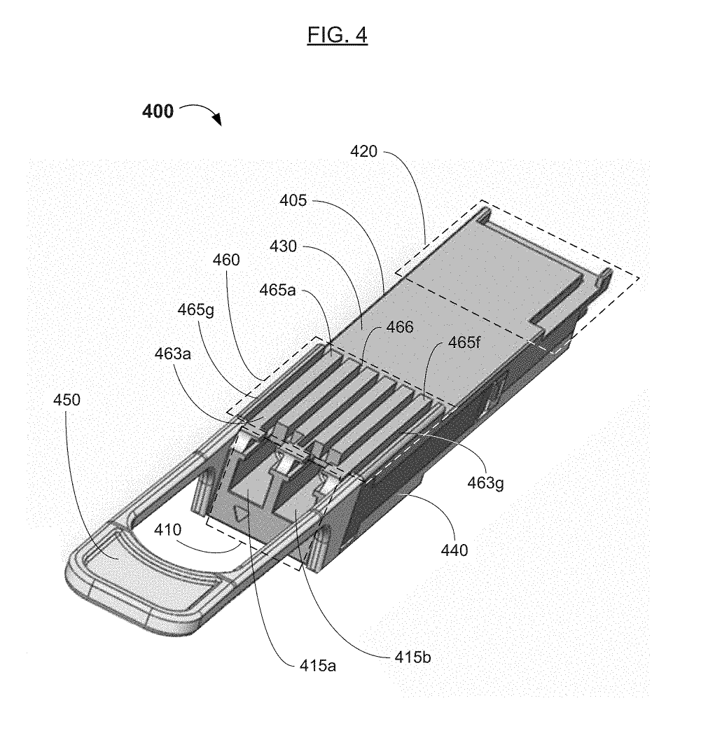

FIG. 4 shows an exemplary optical transceiver 400 including a housing 405, an optical interface 410, optical ports 415a-b, an electrical interface 420, an upper cover 430, a lower cover or base 440, a handle 450, and a heat sink 460. Similarly- or identically-named components of the transceiver 400 may be identical, substantially identical or similar to the similarly- or identically-named components of transceiver 300, except for the heat sink 460.

The heat sink 460 has a non-planar surface and may be over or on, and/or in thermal contact with, the first section of the housing 405. The heat sink 460 may comprise a thermally conductive material (e.g., a metal or metal alloy), and may dissipate heat away from the transceiver 400. The heat sink 460 may be integrated with, or affixed or attached to, the upper cover 430. Alternatively, the heat sink 460 may be integrated with, affixed, or attached to the lower cover or base 440, or both the upper cover 430 and the lower cover or base 440 (e.g., the heat sink 460 may be present on all lateral sides of the housing 405). In some embodiments, the heat sink 460 may encapsulate, enclose or substantially encapsulate or enclose the first section of the housing 405.

The heat sink 460 comprises a plurality of fins or bars 465a-f. The fins or bars 465a-f may be oriented along the length (shown) or width of the transceiver 400. Alternatively, the fins or bars 465a-f may be oriented diagonally, and/or may have one or more angles, bends or curves (e.g., has a non-linear shape or pattern). In further alternative embodiments, the heat sink 460 may have a first section in which the fins or bars 465a-f are oriented along a first dimension (e.g., the length) of the transceiver 400, and a second section in which the fins or bars 465a-f are oriented along a second, optionally orthogonal dimension (e.g., the width) of the transceiver 400. The sidewalls of the fins or bars 465a-f may be straight, angled or curved, and may have angular or curved interfaces with the cover 430 (or a plate secured to the cover 430) and/or an outermost surface of the fins or bars 465a-f.

The fins or bars 465a-f may be spaced apart by a plurality of troughs 466. Each of the fins or bars 465a-f and troughs 466 may have a length and a width. The length of each fin or bar 465a-f and trough 466 may independently be from 5 to 30 mm, or any value or range of values therein. The lengths of the troughs 466 are the same as or less than the lengths of the fins or bars 465a-f. The width of each fin or bar 465a-f and trough 466 may independently be from 0.1 to 5 mm, or any value or range of values therein. The widths of the troughs 466 may be the same as, less than or greater than the widths of the fins or bars 465a-f. The length of each fin or bar 465a-f and trough 466 is generally substantially larger than its width (e.g., from 3 to 1000 times as large, or any value or range of values therein).

Each of the fins or bars 465a-f may have a height that extends away from the surface of the cover 430 or of a plate of the heat sink 460 (e.g., from 0.1 to 20 mm, or any value or range of values therein). In some embodiments, different fins or bars 465a-f may have a different height. Each of the troughs 466 may independently have a depth of from 0.1 to 20 mm, or any value or range of values therein. The depth of the troughs 466 is generally equal to the height of an adjacent fin or bar 465a-f, but it may be less than the height of the adjacent fin or bar 465a-f.

Certain fins or bars (e.g., 465a, 465c, 465d and 465f) may have extensions that are configured to serve a second function. In the example shown in FIG. 4, the extensions are in the optical interface 410, and are configured to receive part of an optical fiber connector. However, other functions are also envisioned (e.g., an outermost fin or bar 465g connecting the housing 405 to the handle 450, etc.).

### A Method of Dissipating Heat from an Optical or Optoelectronic Transceiver

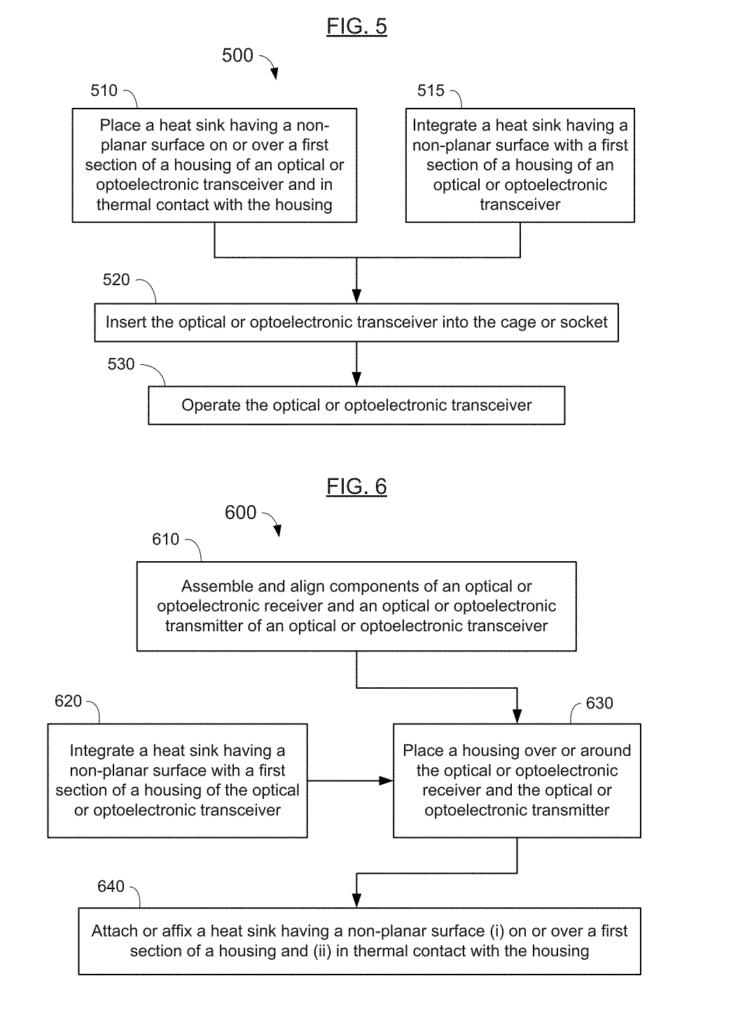

FIG. 5 shows a flowchart 500 describing a method of dissipating heat from an optical or optoelectronic transceiver.

At 510, a heat sink having a non-planar surface is placed on or over a first section of a housing of an optical or optoelectronic transceiver and in thermal contact with the housing, as described herein. Alternatively, more than one heat sink may be placed on or over/under the first section of the transceiver housing. The heat sink(s) may be placed on or over the first or upper cover of the housing and/or on or under the base or the second/lower cover of the housing. For convenience, the remainder of the description of the method of dissipating heat from an optical or optoelectronic transceiver will refer to use of a single heat sink to do so, but the method can easily include more than one heat sink, on the same and/or opposite sides of the optical or optoelectronic transceiver.

Placing the heat sink on or over the first section of the housing may comprise securing (e.g., affixing or attaching) the heat sink to the first section of the housing. In such embodiments, the heat sink may have a plate from which the projections, pillars, fins or bars extend, as described herein. The heat sink may be affixed or attached to the first section of the housing by a mechanical mechanism (e.g., one or more screws, tongue-in-groove fasteners, etc.) or a chemical mechanism (e.g., an adhesive, which may be heat- and/or pressure-activated). Thus, affixing or attaching the heat sink to the first section of the housing may comprise fastening the heat sink to the first section of the housing, or applying an adhesive to an underside of the heat sink and/or an outer surface of the first section of the housing, and contacting the underside of the heat sink to the outer surface of the first section of the housing. Optionally, when affixing or attaching the heat sink to the first section of the housing comprises applying the adhesive, it may further comprise irradiating the adhesive or applying sufficient heat and/or pressure to the heat sink and/or the first section of the housing to activate the adhesive and/or secure the heat sink to the first section of the housing.

Alternatively, the heat sink is integrated with the first section of the housing of the optical or optoelectronic transceiver at 515. In such embodiments, the heat sink and at least one of the covers of the housing in at least the first section of the housing (and preferably the entire cover) comprise or consist of the same material or materials. When the material(s) comprise a thermally-conductive ceramic or plastic, the integrated heat sink and housing cover(s) may be formed by molding (e.g., injection molding) and optionally heating, with or without pressure. When the material(s) comprise a metal or metal alloy, the integrated heat sink and housing cover(s) may be formed by stamping or machining.

At 520, the optical or optoelectronic transceiver into the cage or socket of a host or storage device, as described herein. In some embodiments, a delatching mechanism of the optical or optoelectronic transceiver latches the optical or optoelectronic transceiver in the cage or socket. When inserted in the cage or socket, the first section of the housing remains outside the cage or socket.

At 530, the optical or optoelectronic transceiver is operated normally. As the optical, electrical and optoelectric devices in the optical or optoelectronic transceiver operate or function, heat is generated in the optical or optoelectronic transceiver that is dissipated by the heat sink on or over the first section of the housing and in thermal contact with the housing of the optical or optoelectronic transceiver.

### A Method of Manufacturing an Optical or Optoelectronic Transceiver

FIG. 6 shows a flowchart 600 describing a method of manufacturing an optical or optoelectronic transceiver. At 610, the components of an optical or optoelectronic receiver and an optical or optoelectronic transmitter of an optical or optoelectronic transceiver are assembled and aligned. For example, the transceiver components may be placed or mounted on a board or other substrate and/or on one or more surfaces in an optical cavity, optically aligned, then permanently secured in place when the optical strength of the signal transmitted by the transceiver to the optical fiber, or from the optical fiber to the receiver, are maximized or above a predetermined threshold.

In general, the components of the optical or optoelectronic receiver include a photodiode (e.g., an avalanche photodiode) and one or more amplifiers. For example, the amplifier(s) may comprise a transimpedence amplifier (TIA) configured to amplify an electrical signal from the photodiode and/or a limiting amplifier configured to amplify the output from the TIA (when present) or the electrical signal from the photodiode.

Generally, the components of the optical or optoelectronic transmitter include a laser driver and a laser diode. The laser driver is generally configured to (i) receive an electrical signal (e.g., comprising data) from a host or storage device and (ii) provide an output signal to the laser diode. The laser diode is configured to convert the output signal to an outgoing optical signal. In some embodiments, the optical or optoelectronic transmitter further comprises (1) a bias circuit configured to provide a bias signal (e.g., a bias current or a bias voltage) to the laser diode and/or (2) a modulator configured to modulate the outgoing optical signal from the laser diode. When the modulator is present, the combination of the modulator and the laser diode may be an electromodulated laser (EML). Each of the receiver and transmitter may independently further include a lens adjacent to an optical fiber connector and/or a mirror or beam combiner in the optical path between the lens and the laser diode or photodiode.

At 620, one or more heat sinks having a non-planar surface is/are integrated with a first section of a housing of the optical or optoelectronic transceiver, as described herein. For example, an integrated heat sink and housing cover may be formed as described with respect to integrating the heat sink with the first section of the transceiver housing at 515 in FIG. 5. The heat sink(s) may be integrated with the first or upper cover, the second or lower cover (e.g., the base), or both.

At 630, the housing is placed over or around the optical or optoelectronic receiver and the optical or optoelectronic transmitter. As described herein, the housing may comprise a first or upper cover and a base or a second or lower cover. When the housing is in two (or more) sections, the sections may be secured to each other by snapping them together or sliding one section into the other (e.g., using a tongue-in groove fitting), or by screwing one cover to the other. When the housing is unitary, the housing can be slid over the components of the transceiver (e.g., on a board or substrate), or the optical or optoelectronic receiver and the optical or optoelectronic transmitter can be placed in the housing of transceiver.

At 640, if the heat sink(s) is/are not integrated with the housing, the heat sink(s) is/are attached or affixed (i) on or over the first section of the housing and (ii) in thermal contact with the housing, as described herein (see, e.g., the discussion of 510 in FIG. 5). The heat sink(s) may thus have a plate from which the projections, pillars, fins or bars extend, as described herein. Affixing or attaching the heat sink(s) to the first section of the housing may comprise mechanically affixing or attaching (e.g., screwing, clipping, snapping, pressing, etc.) the heat sink(s) to the housing, or adhering the heat sink(s) to the housing (and, optionally, heating, irradiating, and/or applying pressure to the heat sink(s) and/or the housing).

### CONCLUSION/SUMMARY

The foregoing descriptions of specific embodiments of the present invention have been presented for purposes of illustration and description. They are not intended to be exhaustive or to limit the invention to the precise forms disclosed, and obviously many modifications and variations are possible in light of the above teachings. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. An optical or optoelectronic transceiver, comprising:
an optical or optoelectronic receiver, comprising a receiver optical subassembly (ROSA);
an optical or optoelectronic transmitter, comprising a transmitter optical sub assembly (TOSA);
a plurality of electrical devices, each configured to provide or control one or more functions of the optical or optoelectronic receiver and the optical or optoelectronic transmitter;
a small form factor-compliant housing over and/or enclosing the optical or optoelectronic receiver and the optical or optoelectronic transmitter, the small form factor-compliant housing having a first section and a second section and being configured to (a) be removably insertable into a cage or socket of a host or storage device and (b) position the first section of the small form factor-compliant housing outside the cage or socket when the small form factor-compliant housing is inserted in the cage or socket; and
a thermally conductive heat sink having a non-planar surface, on or over to the first section and in thermal contact with the small form factor-compliant housing, configured to dissipate heat away from the transceiver, wherein the non-planar surface of the heat sink comprises (i) a plurality of cuboid, rectangular, cylindrical, hexagonal or pin-like projections or pillars in a matrix of n rows and m columns, where each of n and m is independently an integer of 2 or more, or (ii) a plurality of alternating ridges and troughs, each having a longest dimension with an axis that is parallel with an axis along a longest dimension of the small form factor-compliant housing.

2. The optical or optoelectronic transceiver of claim 1, wherein the thermally conductive heat sink is integrated with the small form factor-compliant housing.

3. The optical or optoelectronic transceiver of claim 1, wherein the small form factor-compliant housing comprises a cover and a base.

4. The optical or optoelectronic transceiver of claim 3, wherein the thermally conductive heat sink is integrated with the cover.

5. The optical or optoelectronic transceiver of claim 3, wherein the thermally conductive heat sink is integrated with the base.

6. The optical or optoelectronic transceiver of claim 3, further comprising a second heat sink substantially identical to the thermally conductive heat sink.

7. The optical or optoelectronic transceiver of claim 6, wherein one of the thermally conductive and second heat sinks is in thermal contact with the cover and the other one of the thermally conductive and second heat sinks is in thermal contact with the base.

8. (canceled)

9. The optical or optoelectronic transceiver of claim 1, wherein the non-planar surface of the thermally conductive heat sink comprises the plurality of cuboid, rectangular, cylindrical, hexagonal or pin-like projections or pillars.

10. (canceled)

11. The optical or optoelectronic transceiver of claim 9, where each of n and m is independently an integer of 2 or more.

12. The optical or optoelectronic transceiver of claim 1, wherein the non-planar surface of the heat sink comprises the plurality of alternating ridges and troughs.

13. (canceled)

14. The optical or optoelectronic transceiver of claim 1, further comprising a de-latching mechanism configured to latch or secure the small form factor-compliant housing to the cage or socket, and de-latch or release the housing from the cage or socket.

15. The optical or optoelectronic transceiver of claim 1, wherein the second section of the small form factor-compliant housing is removably insertable into the cage or socket of the host device.

16. A method of dissipating heat from an optical or optoelectronic transceiver, comprising:
placing a thermally conductive heat sink having a non-planar surface (i) over or adjacent to a first section of a small form factor-compliant housing of the optical or optoelectronic transceiver and (ii) in thermal contact with the small form factor-compliant housing, the optical or optoelectronic transceiver comprising
an optical or optoelectronic receiver, comprising a receiver optical subassembly (ROSA),
an optical or optoelectronic transmitter, comprising a transmitter optical subassembly (TOSA), and
a plurality of electrical devices, each configured to provide or control one or more functions of the optical or optoelectronic receiver and the optical or optoelectronic transmitter,
wherein the small form factor-compliant housing encloses and/or is over the optical or optoelectronic receiver and the optical or optoelectronic transmitter, and the small form factor-compliant housing is configured to (a) be removably insertable into a cage or socket of a host or storage device, and (b) position the first section outside the cage or socket when the small form factor-compliant housing is inserted in the cage or socket and (c) dissipate heat away from the transceiver, wherein the non-planar surface of the heat sink comprises (i) a plurality of cuboid, rectangular, cylindrical, hexagonal or pin-like projections or pillars in a matrix of n rows and m columns, where each of n and m is independently an integer of 2 or more, or (ii) a plurality of alternating ridges and troughs, each having a longest dimension with an axis that is parallel with an axis along a longest dimension of the small form factor-compliant housing;
inserting the optical or optoelectronic transceiver into the cage or socket; and
operating the optical or optoelectronic transceiver.

17. The method of claim 16, comprising inserting the second section of the small form factor-compliant housing into the cage or socket of the host or storage device.

18. A method of manufacturing an optical or optoelectronic transceiver, comprising:
placing a small form factor-compliant housing over an optical or optoelectronic receiver and an optical or optoelectronic transmitter of the optical or optoelectronic transceiver, the optical or optoelectronic receiver comprising a receiver optical subassembly (ROSA), the optical or optoelectronic transmitter comprising a transmitter optical subassembly (TOSA), and the optical or optoelectronic transceiver further comprising a plurality of electrical devices, each configured to provide or control one or more functions of the optical or optoelectronic receiver and the optical or optoelectronic transmitter;
attaching, affixing or integrating a thermally conductive heat sink having a non-planar surface (i) to, on or over a first section of the small form factor-compliant housing and (ii) in thermal contact with the small form factor-compliant housing, wherein the small form factor-compliant housing further comprises a second section, and the small form factor-compliant housing is configured to (a) be removably insertable into a cage or socket of a host or storage device and (b) position or house the first section outside the cage or socket when the small form factor-compliant housing is inserted in the cage or socket, the thermally conductive heat sink is configured to dissipate heat away from the transceiver, and the non-planar surface of the heat sink comprises (1) a plurality of cuboid, rectangular, cylindrical, hexagonal or pin-like projections or pillars in a matrix of n rows and m columns, where each of n and m is independently an integer of 2 or more, or (2) a plurality of alternating ridges and troughs, each having a longest dimension with an axis that is parallel with an axis along a longest dimension of the small form factor-compliant housing.

19. The method of claim 18, wherein the second section of the small form factor-compliant housing is removably insertable into the cage or socket of the host device.

20. The method of claim 18, comprising integrating the thermally conductive heat sink into the small form factor-compliant housing.

21. The method of claim 16, wherein the small form factor-compliant housing comprises a cover and a base, the thermally conductive heat sink is integrated with the cover, and the method further comprises placing a second heat sink substantially identical to the thermally conductive heat sink in thermal contact with the base.

22. The method of claim 16, wherein the non-planar surface of the thermally conductive heat sink comprises the plurality of cuboid, rectangular, cylindrical, hexagonal or pin-like projections or pillars.

23. The method of claim 18, wherein the non-planar surface of the thermally conductive heat sink comprises the plurality of cuboid, rectangular, cylindrical, hexagonal or pin-like projections or pillars.
